(19) United States
(12) Patent Application Publication
(10) Pub. No.: US 2010/0000510 A1
(43) Pub. Date: Jan. 7, 2010

(54) Industrial baking oven

(76) Inventor: Michael Koos, Arnstein (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/311,144

(22) PCT Filed: Sep. 14, 2007
(86) PCT No.: PCT/EP2007/059685

§ 371 Date: Mar. 19, 2009

(30) Foreign Application Priority Data
Sep. 21, 2006 (DE) 10 2006 045 096.5

(51) Int. Cl. F24C 15/02; B23P 19/04

(52) U.S. Cl. 126/194; 29/700

(57) ABSTRACT

A baking oven has an oven housing, an oven door which is connected to the oven housing with a hinge at one side, and cooperating sealing elements on the door and in the area of the door opening of the oven housing. The sealing elements include a flexible seal and a seal-contact surface. The sealing elements situated in the vicinity of the upper edge of the door and those being situated in the vicinity of the lower edge of the door having different designs. The sealing elements provided on the door near the upper and lower door edges are releasably attached to the door, so they are interchangeable to improve the ease of installing the door alternatively with a right hinge or a left hinge.

### TECHNICAL FIELD

The present invention relates to a baking oven having
an oven housing,
an oven door which is connected to the oven housing with a hinge at one side, and
cooperating sealing elements on the door and in the area of the door opening of the oven housing,
   the sealing elements including a flexible seal and a seal-contact surface, and the sealing elements being situated in the vicinity of the upper edge of the door and those being situated in the vicinity of the lower edge of the door having different designs.

The present invention relates in particular to a baking oven for inserting a baking cart, also known as a multi-tray cart. Such baking ovens are also known as baking cabinets and allow a baker to simultaneously bake a large number of baked goods which are situated on several baking trays situated one above the other on the baking cart. The baking carts have rollers which stand on the floor. The baking carts are pushed through an oven door into the baking chamber of the baking oven.

### BACKGROUND INFORMATION

The baking oven housing has on its front side an opening, which leads to the baking chamber. The baking oven housing forms a frame for the door laterally and above this opening. Preferably only a very shallow threshold is provided in the lower area or none at all, so that the rollers on the multi-tray cart are not hindered during insertion into the baking chamber.

For this reason, the door seals on the lateral edges and on the upper edge of the door are different from the door seal in the lower area of the door. Sealing profiles made of elastic materials, which bear against a seal-contact surface when the door is closed and seal the oven completely, are preferably provided at the top and sides. The elastic sealing profiles may be attached either to the door or in the area of the door opening of the oven housing. The seal-contact surfaces are formed by the surfaces opposite the sealing profiles when the door is closed. A sealing strip is often used in the lower area, coming in contact with the floor in the area of the door opening and thereby sealing the baking chamber from the environment of the oven. To prevent this sealing strip from rubbing over the floor in the opening movement of the oven door, the lower hinge with which the oven door is attached to the oven housing often has a lifting device. This lifting device causes the door to be raised during opening, so that, when the door is swung open, the lower seal moves at a distance over the floor surface.

Due to the complex design of such an industrial baking oven and its door in particular, it is necessary to manufacture different doors for baking ovens having right-hung doors and baking ovens having left-hung doors. Often it is not discovered until the time of installation that the door hinge side originally ordered cannot be implemented. Given the spatial situation, a right-hung door may be impractical or may collide with other equipment in the bakery during the movement of opening the door. In such a case, it is necessary to supply a door whose hinge connection to the oven housing is on the other side. This door is thus designed in mirror image to the door originally ordered. Resupplying a door with the door hinge on the other side often means a delay of several days in the installation work of a baking oven. This may result in considerable loss of production in the affected bakery or production plant for baked goods. If the door is not in stock, it would have to be manufactured by special order. Delivery of a door having a different hinge then takes several weeks. During this time, the baker must settle for a temporary solution in which the old hinge position of the door originally ordered is selected.

### DISCLOSURE OF THE INVENTION

The object of the present invention is to overcome this disadvantage of a time lag in the case of a change of the side of the door hinge.

This object is achieved according to the present invention by the fact that the sealing elements provided on the door near the upper and lower door edges are releasably attached to the door, so they are interchangeable.

If the same door should be used for mounting on the oven housing with a right hinge and a left hinge, then it must be rotatable by 180° in the plane of the door. In this way, the door hinges and the closing device for the door are each then provided on the other side. If the door hinges are asymmetrical, e.g., a lifting device is integrated into the hinge in the lower area, then the door hinges must also be replaced after rotating.

This rotation in the plane of the door, which is known with household baking ovens, which have identical peripheral seals, is impossible with known doors for industrial baking ovens. Due to the rotation, the different seals close to the upper edge of the door and close to the lower edge of the door are each on the wrong side. They therefore lose their function and the door is no longer reliably closable.

With the door according to the present invention, the sealing elements are releasably and exchangeably secured in the area of the upper and lower edges of the door. For this reason, the seals at the top and bottom are interchangeable after a 180° rotation of the door in its plane. The door may then be hinge-mounted on the other side of the door opening of the oven housing. Retrofitting a door takes only a few hours and may easily be integrated into the usual sequence in installation of an industrial baking oven.

In a practical embodiment, all the sealing elements may be detachably attached to the door. In particular, the elastically deformable sealing elements may be attached to the door which are attached to the door in the correct position when the hinge side of the door is changed.

As already mentioned, the seal near the lower door edge is preferably an elastic sealing strip. A hollow profile seal made of elastic and heat-resistant silicone is preferably provided parallel to each of the side and upper door edges. The elastic sealing elements may in practice be provided on the door wing, whereas the seal-contact surfaces may be in the area of the door opening. For the lateral seals and the upper seal, they are formed by the outside surface of the oven housing in the area of the door opening. The seal-contact surface for the lower seal is the floor surface in the area of the door opening.

All the sealing elements of the door may be detachably and displaceably attached. The hollow profile seals are in practice displaceable in a direction perpendicular to the plane of the door.

During assembly and during subsequent maintenance work, the seals may be released and attached to the door in an optimum position. The position is to be selected in such a way that the seal bears against the seal-contact surface with a predefined pressure and the baking chamber is sealed airtight. The sealing strip in the lower area of the door may be displaceable toward the bottom and parallel to the plane of the door to ensure an optimum press-on force onto the floor.

In practice, the door handle may be provided in the center between the upper and lower edges of the door. This results in the door handle always being situated at the same optimum operating height, regardless of the installed position.

At least one bolt which locks the door in the door opening of the housing is provided on the door edge opposite the hinges. In practice, two bolts situated close to the upper end and close to the lower end of the door edge may be operated by the door handle, although it is also possible to close the door by a single bolt at the height of the door handle. A door of an industrial baking oven often sags during operation due to the great temperature changes. Locking the door in the vicinity of the upper and lower ends of the door edge which is opposite the hinges ensures a reliable and sealing closing of the door.

In practice and further, a hinge with a lifting device which lifts the door on opening may be provided on the lower edge of the door. The hinges on the door is to be detachably attached so that the hinge with the lifting device may be mounted either in the lower right corner of the door or, after rotating the door, in the lower left corner of the door.

### BRIEF DESCRIPTION OF THE DRAWINGS

A practical embodiment of the present invention is described in greater detail below with reference to the accompanying drawings.

FIG. 1 shows a front view of a baking oven according to the present invention,

FIG. 2 shows a sectional view of a baking oven with a baked goods tray in it, and

FIG. 3 shows a top view of the inside of the door of the baking oven from FIGS. 1 and 2,

FIG. 4 shows a side view of the door from FIG. 3,

FIG. 5 shows a sectional view of the door along sectional line V-V in FIG. 3, and

FIG. 6 shows a sectional view of the door along sectional line VI-VI in FIG. 3.

### EMBODIMENT(S) OF THE INVENTION

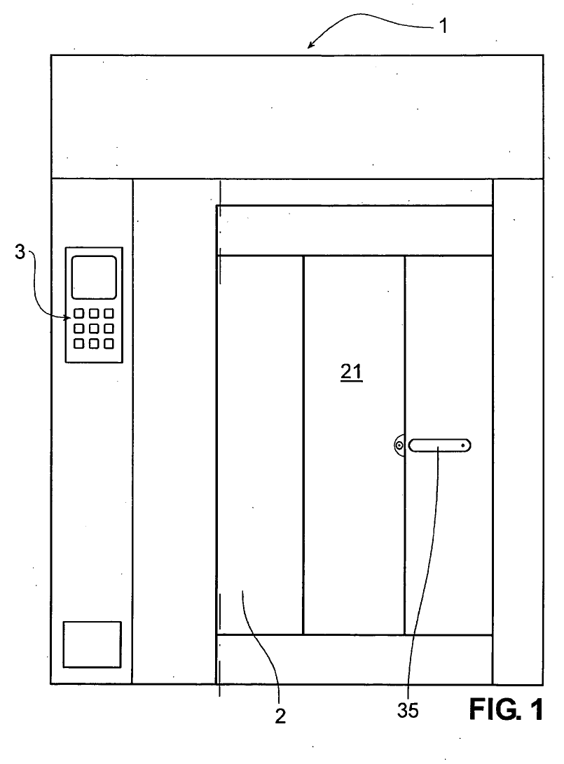

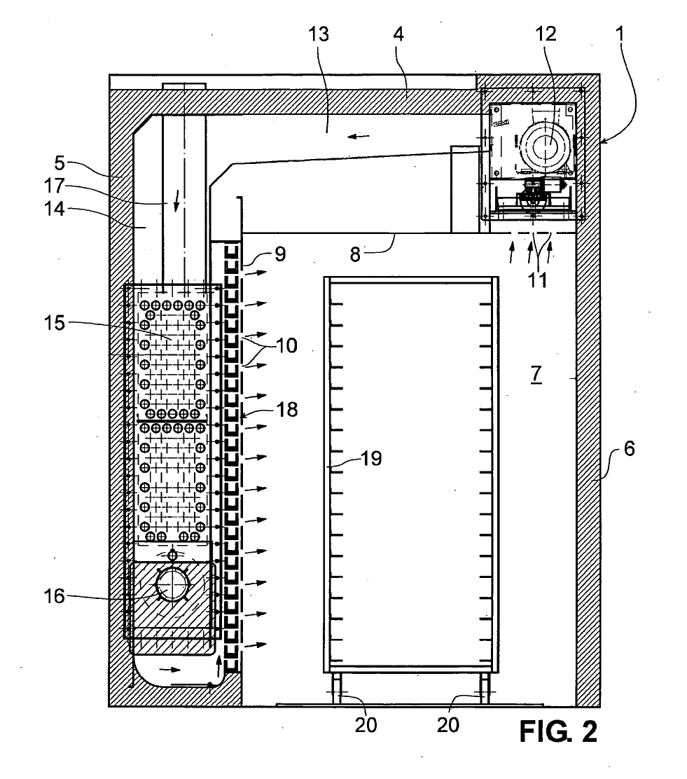

FIG. 1 shows an industrial baking oven according to the present invention which is usually used in bakeries or in industrial baking facilities. The baking oven has a housing 1 with a door 2, which is closed during the baking operation and is openable for introducing and removing the baked goods. Door 2 is approximately 2 meters tall and extends to the floor without a threshold. This ensures that a baking cart 19 (see FIG. 2), also known as a multi-tray cart, may be pushed into baking chamber 7 of the baking oven through the door opening when door 2 is opened. Baking cart or multi-tray cart 19 is equipped with rollers 20 which roll over the floor.

FIG. 1 also shows an operating field 3 having a display screen. Parameters of the baking operation (e.g., duration, temperature, vapor) may be input via operating field 3 and then displayed on the display screen of operating field 3 for control.

As shown in the sectional diagram in FIG. 2, housing 1 has a thermally insulated top wall 4 and thermally insulated side walls 5, 6. A baking chamber 7 is formed inside thermally insulated walls 4 to 6 of housing 1. Baking chamber 7 is bordered at the top by a cover wall 8 and at the sides by a side wall 9. Cover wall 8 and side wall 9 of baking chamber 7 are usually formed by a stainless steel plate. Inlet openings 10 through which heated air flows into baking chamber 7 are provided in side wall 9. Outlet openings 11 through which air flows out of baking chamber 7 are provided in cover wall 8.

A fan 12 is installed in the upper right corner of housing 1 above cover wall 8 and in particular above outlet openings 11.

A horizontal flow channel 13 running essentially parallel to top wall 4 of the housing is connected to fan 12. A vertical flow channel 14 in which heating register 15 and burner 16 are situated is connected to horizontal flow channel 13. FIG. 2 also shows exhaust pipe 17 of burner 16. Heated air flows from burner 16 through a vapor apparatus 18 to wall 9 having inlet openings 10.

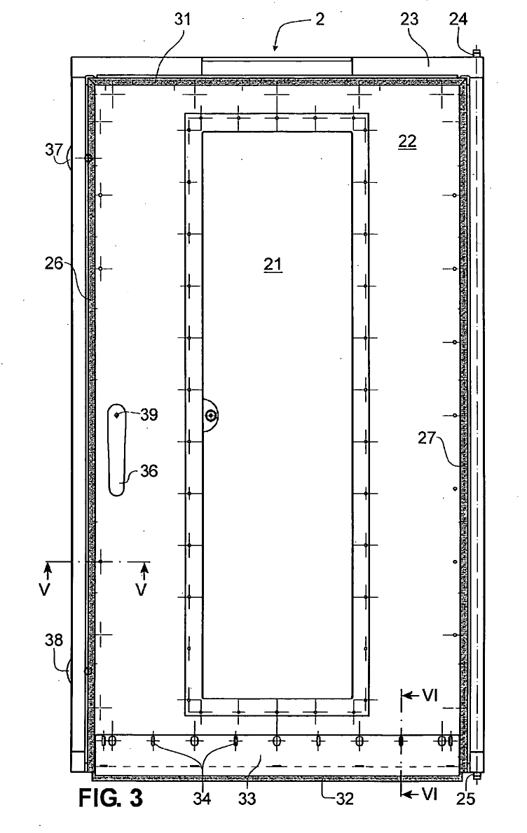

FIGS. 3 through 6 show details of door 2 of the baking oven according to the present invention.

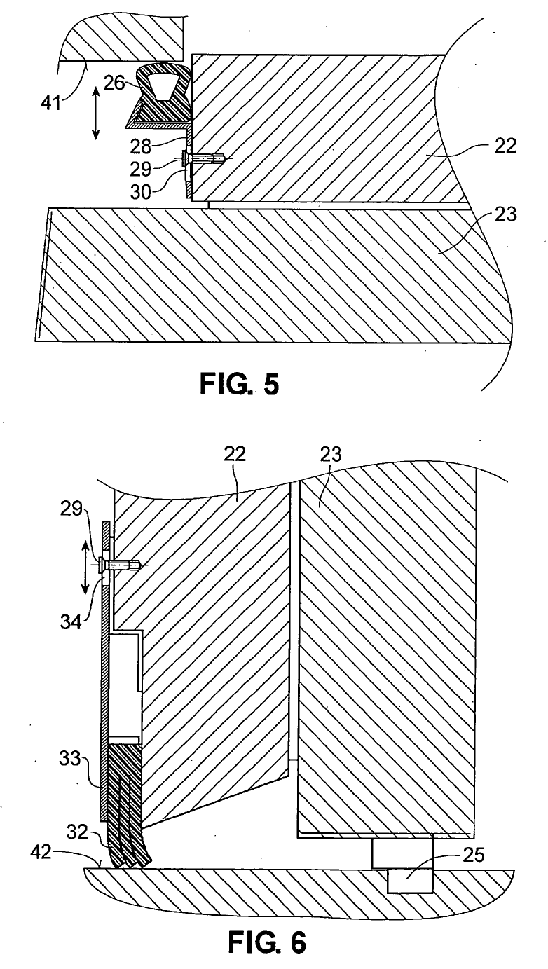

Door 2 has in the middle an inspection window 21 made of transparent material, preferably a heat-resistant glass. At the side of inspection window 21, door 2 is made of stainless steel. As shown in FIGS. 5 and 6 in particular, door 2 has two flat components 22, 23 connected to one another. These components hold different functional elements of door 2 and are designed to provide thermal insulation to minimize heat loss out of baking chamber 7. Hinge pins 24, 25 are provided on outer component 23.

Two lateral seals 26, 27 are provided on inner component 22 parallel to the side edges. Side seal 26 is shown enlarged in FIG. 5. Seal 26 is formed by a hollow profile of elastic heat-resistant silicone. It is attached to component 22 of door 2 situated on the inside, i.e., toward baking chamber 7 by a retaining strip 28. As shown in FIG. 5, retaining strip 28 is secured by loosenable fastening screws 29. Fastening screws 29 pass through elongated holes 30 in retaining strip 28. By loosening all fastening screws 29, retaining strip 28 and thus sealing profile 26 are displaceable at a right angle to the plane of door 2, i.e., toward or away from the baking chamber. This achieves the result that when door 2 is closed, lateral seal 26 is always in optimum contact with seal-contact surface 41 formed by the outside surface of oven housing 1 in the area of the door opening. One upper seal 31 and the other lateral seal 27 are made of the same hollow profile as seal 26 shown in FIG. 5 and are attached to outer component 22 of door 2 in the same way, so that they are also displaceable at a right angle to the plane of door 2.

Lower seal 32 is shown in enlarged form in FIG. 6. It has a sealing strip of elastically deformable and heat-resistant material. In the present case, the sealing strip is divided into various strips to achieve an optimum sealing effect. Lower seal 32 is attached by a fastening plate 33 close to the lower edge of door 2. Fastening plate 33 also has elongated holes 34 through which fastening screws 29 pass. Fastening plate 33 is vertically displaceable in the plane of door 2 with the aid of this fastening. In other words, this allows an adjustment of the distance of lower seal 32 to floor surface 42, which forms the seal-contact surface for lower seal 32.

All fastening screws 29 may be completely loosened so that all seals 26, 27, 31 and 32 may be removed from the door leaf.

The door is configured in FIG. 3 in such a way that hinge pins 24, 25 are attached to the right edge of the inside of door 2 (to the left edge of door 2 as seen from the outside).

If door 2 is to come to be hung on the other side, it must be rotated by 180° in its plane. At least seals 31 and 32 are then removed completely and screwed on again after rotating door 2 by 180°. Lower seal 32 is then situated in the area of the edge of the door, where upper seal 31 has previously been situated.

To this end, the threads for receiving fastening screws 29 for upper seal 31 on the one hand and also for lower seal 32 on the other hand are provided in the area of the upper edge and also in the area of the lower edge.

Lateral seals 26, 27 may be attached to the same receptacles for fastening screws 29 in both orientations, i.e., with the hinge axle of door 2 on the right and with the hinge axle of door 2 on the left. It is shown here that the lateral seals are at a distance of a few centimeters from the upper edge of door 2 but extend all the way to the lower edge of door 2. The hole pattern of threaded holes for fastening screws 29 is to be situated on each edge of door 2, in such a way that lateral seals 26, 27 may each be flush with the two transverse edges, depending on the orientation of the door (2).

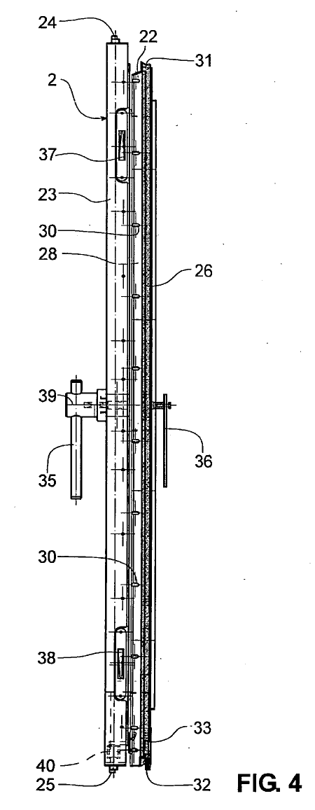

FIG. 4 shows an exterior door handle 35 and an interior door handle 36, which are mounted on a shared rotating axis 39. Rotating axis 39 acts on a drive linkage in door 2 to operate two bolts 37, 38. Rotating axis 39 of door handles 35, 36 is situated exactly at the center between the upper edge and the lower edge of door 2. This ensures that door handles 35, 36 are at the same height above the floor with both a right hinge and a left hinge of door 2.

FIG. 4 indicates that a lifting device 40 integrated into exterior flat component 23 of the door is assigned to lower hinge pin 25. This lifting device 40 raises door 2 when opened. This raises lower seal 32 from the floor, thereby reducing the wear on lower seal 32. When the door leaf is rotated to be hung on the other side, lifting device 40 is also to be removed and attached jointly with hinge pin 25 close to the lower edge of the rotated door.

### LIST OF REFERENCE NUMERALS

1 housing
2 door
3 operating field
4 top wall
5 side wall
6 side wall
7 baking chamber
8 cover wall
9 side wall
10 inlet opening
11 outlet opening
12 fan
13 horizontal flow channel
14 vertical flow channel
15 heating register
16 burner
17 exhaust pipe
18 vapor apparatus
19 baking cart
20 roller
21 inspection window
22 flat component
23 flat component
24 hinge pin
25 hinge pin
26 lateral seal
27 lateral seal
28 retaining strip
29 fastening screw
30 elongated hole
31 upper seal
32 lower seal
33 fastening plate
34 elongated hole
35 exterior door handle
36 interior door handle
37 bolt
38 bolt
39 rotating axis
40 lifting device
41 seal-contact surface, outside surface of the oven housing
42 seal-contact surface, floor surface

1. A baking oven, comprising
an oven housing;
an oven door which is connected to the oven housing with a hinge at one side; and
cooperating sealing elements on the door and in the area of the door opening of the oven housing, the sealing elements including at least one flexible seal and a seal-contact surface, wherein the sealing elements situated in the vicinity of an upper door edge and the sealing elements in the vicinity of a lower door edge have different designs, and wherein the sealing elements situated on the door in the vicinity of the upper and lower door edges are detachably and interchangeably attached to the door.

2. The baking oven as recited in claim 1, further comprising:
a sealing strip provided in the vicinity of the lower door edge; and
a sealing hollow section provided parallel to the upper and side door edges.

3. The baking oven as recited in claim 1, wherein all the sealing elements attached to the door are detachably and displaceably secured.

4. The baking oven as recited in claim 1, further comprising:
at least one door handle provided in the center between the upper edge and the lower edge of the door.

5. The baking oven as recited in claim 4, further comprising:
two bolts provided on the upper and lower ends of a door edge, wherein the two bolts are operable using the door handle.

6. The baking oven as recited in claim 1, further comprising:
a hinge having a lifting device provided on the lower edge of the door, the door being raisable by the lifting device when opened, the hinge being detachably attached to the door so that the hinge is mountable on left side and right side door edges.

7. A baking oven, comprising:
an oven housing;
an oven door which is coupled to the oven housing at a first side;
a sealing element disposed in a vicinity of an upper door edge of the oven door; and
a sealing element disposed in a vicinity of a lower door edge of the oven door, wherein the sealing element disposed in the vicinity of the upper door edge has a different design from the sealing element in the vicinity of the lower door edge, and wherein the sealing element disposed in the vicinity of the upper door edge and the sealing elements disposed in the vicinity of the lower door edge are detachable from the door and are interchangeable with each other.

8. The baking oven as recited in claim 7, wherein each of the sealing elements includes at least one flexible seal and a seal-contact surface.

9. The baking oven as recited in claim 7, further comprising:
a sealing strip provided in the vicinity of the lower door edge; and
a sealing hollow section provided parallel to upper door edge.

10. The baking oven as recited in claim 7, wherein all the sealing elements coupled to the door are detachably and displaceably secured.

11. The baking oven as recited in claim 7, further comprising:
a door handle disposed between the upper door edge and the lower door edge of the oven door.

12. The baking oven as recited in claim 11, further comprising:
two bolts provided in the vicinity of the upper door edge and in the vicinity of the lower door edge, wherein the two bolts are operable using the door handle.

13. The baking oven as recited in claim 7, wherein the oven door is coupled to the oven housing using a hinge.

14. The baking oven as recited in claim 13, wherein the hinge is detachably mountable to the first side and to a second side of the oven door.

15. The baking oven as recited in claim 13, wherein the hinge is provided on the lower door edge of the oven door and includes a lifting device, wherein the oven door is raisable using the lifting device when opened.

16. A method of mounting an oven door, comprising:
coupling a first side of an oven door to an oven housing;
attaching a sealing element in a vicinity of an upper door edge of the oven door;
attaching a sealing element in a vicinity of a lower door edge of the oven door, wherein the sealing elements attached in the vicinity of the upper door edge have a different design from the sealing element attached in the vicinity of the lower door edge;
detaching both of the sealing elements from the oven door; and
interchanging and reattaching the sealing elements to the oven door.

17. The method according to claim 16, wherein, after interchanging and reattaching the sealing elements to the oven door, the first side of the oven door is decoupled from the oven housing and a second side of the oven door is coupled to the oven housing.

18. The method according to claim 16, wherein the first side of the oven door is coupled to the oven housing using a hinge.

19. The method as recited in claim 18, wherein the hinge is detachably mountable to the first side and a second side of the oven door.

20. The method as recited in claim 18, wherein the hinge is provided on the lower door edge of the oven door and includes a lifting device, wherein the oven door is raised using the lifting device when opened.
